(19) United States
(12) Patent Application Publication
(10) Pub. No.: US 2008/0205849 A1
(43) Pub. Date: Aug. 28, 2008

(54) SYSTEMS FOR CONTROLLING ACCESS TO LOCKED CONTENT CONTAINED IN A RECORDING MEDIUM

(76) Inventor: Paul Francis Gaston, Norfolk (GB)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,937

(22) Filed: Sep. 7, 2007

(30) Foreign Application Priority Data
Feb. 24, 2007 (GB) 0703655.1

(51) Int. Cl. H04N 5/91

(52) U.S. Cl. 386/95; 386/E05.001

(57) ABSTRACT

A communication apparatus located remotely from an individual entering into communication with said apparatus, includes a module for: receiving a key signal uniquely representative of an individual at a remote communication apparatus; further receiving a signal representative of a specific recording medium; determining a signal representative of one or more personal identification characters based on said key signal and said recording medium signal; and transmitting said signal representative of said personal identification characters.

### CROSS-REFERENCE TO RELATED APPLICATIONS

This application claims priority to United Kingdom Application No. 0703655.1, filed Feb. 24, 2007, which is incorporated herein by reference in its entirety.

### BACKGROUND OF THE INVENTION

1. The Field of the Invention

The invention relates to systems for controlling access to locked content contained in a recording medium, methods for controlling the access, communication apparatuses and/or recording media.

2. The Relevant Technology

The following prior Patent documents are acknowledged: WO2005/057574 and FR2894349.

FR2894349 is an example of the prior art approach to protecting contents on a DVD recording medium and its unlocking. This prior art system would assign a specific personal identification number (PIN), which would be stored on each DVD. In the event that an individual makes a PIN available in the public domain, anybody would be able to unlock the DVD content. The prior art method of unlocking DVD content involves the steps of: loading a DVD on an appropriate reader, viewing a data field for entry of a PIN number, calling a number displayed on the display unit in order to obtain the necessary PIN, and inputting the PIN by using conventional remote control technology. Provided the PIN entered through the DVD menu box corresponds to the PIN provided on the DVD, the DVD content is unlocked. If the PIN number entered is incorrect a further screen appears from the menu program informing the individual trying to read the recording medium that the incorrect number has been entered and in order to view the film a correct code is necessary. A reminder to call the telephone number in order to receive the PIN number corresponding to the recording medium then appears on the screen.

On of the objects of the invention is to avoid having to store the actual PIN on a DVD or any other media produced. Another object of the invention is to allow multiple items to be locked on a single recording medium each with their own unique PINs derived through a new system. Further objects are defined below.

### SUMMARY OF THE INVENTION

In a first broad independent aspect, the invention provides a system for controlling access to locked content contained in a recording medium, comprising:

a) A first module operating from a remote communication apparatus in conjunction with:
a receiver for receiving a key signal uniquely representative of an individual; and for further receiving a signal representative of a specific recording medium;
a generator for determining a signal representative of one or more personal identification characters based on said recording medium signal; and
a transmitter for transmitting said signal representative of said personal identification characters to said individual;

b) A second module operating from said recording medium in conjunction with:
a generator for generating a data field for entry of said key signal; and for generating a further data field for entry of said signal representative of said personal identification characters; and
a comparator for assessing the accuracy of said personal identification characters which compares signals derived from said key signal and said particular recording medium signal with signals derived from said personal identification characters;

Whereby when said comparator determines that said personal identification characters correspond to a particular recording medium signal and key signal, said second module causes said locked content to be accessible.

This configuration is particularly advantageous because it avoids having to store the actual PIN or personal identification characters on a DVD or other media produced. Due to the operation of the modules it prevents full reverse engineering. This system may also be operated on a per content basis so that multiple items of locked content can be placed on a single media each with their own unique personal identification characters.

It also allows a user to view the content as many times as he/she wishes once the personal identification characters are obtained for a given content item.

This system may also operate on any form of DVD or other media, which can be placed into an industry standard DVD player including dual layer.

In a subsidiary aspect in accordance with the invention's first broad independent aspect, said specific recording medium signal incorporates a portion, which is permanently stored on said recording medium, which is common to a particular kind of recording medium and a portion, which is specific to an individual recording medium. This is particularly advantageous because each DVD or recording medium issued may have a product identifier registered with an operator and a part encoded onto the recording medium via a virtual machine instruction set (VMIS). In these circumstances, when a third party attempts to use a personal identification character or personal identification characters issued for a DVD with a different product code, the system would fail to authenticate the personal identification characters so that the content would remain blocked. If the third party would attempt to reverse engineer the module they would be missing the full product code since it may not be stored in its entirety on the recording medium.

In a further subsidiary aspect, the invention provides a recording medium which incorporates a plurality of viewing angles for a plurality of video portions; and wherein a single video stream is located onto one of said views which displays a message indicating said content is locked whilst said content is located on another view. This configuration is particularly advantageous because it allows content of the recording medium to be kept locked even when the recording medium is read by a software based DVD player such as used on a standard PC running the Windows operating system (Windows is a trademark of Microsoft).

In a further subsidiary aspect, the system further comprises means for locking a display on said view in response to an attempt to view locked content prior to entering said signal representative of said personal identification characters. This configuration is particularly advantageous because it protects content even when read by a software based DVD player.

The system may incorporate a module which when a valid personal identification character is entered causes a VMIS command to be issued which flips the view to show the unlocked video. This configuration is particularly advantageous because such a command may only be issued via the recording medium itself so that it becomes much more difficult for an individual to bypass the personal identification characters' protection.

In a further subsidiary aspect, said key signal is a telephone number. This configuration is particularly advantageous because the number may be readily manipulated through appropriate algorithms in the production of a personal identification character or characters. It also has the secondary benefit of specifically identifying individuals. This would act as a deterrent for individuals to release the key signal to other members of the public since they would run the risk of being pestered by the public and an operator could trace the individual responsible for releasing the content and the information necessary to unlock it.

In a second broad independent aspect, the invention provides a method for controlling access to locked content contained in a recording medium, comprising the following steps:
receiving a key signal uniquely representative of an individual at a remote communication apparatus;
further receiving a signal representative of a specific recording medium;
determining a signal representative of one or more personal identification characters based on said key signal and said recording medium signal;
transmitting said signal representative of said personal identification characters;
generating a data field for entry of said key signal by reading said recording medium in a reading apparatus;
generating a further data field for entry of said signal representative of said personal identification characters by reading said recording medium in a reading apparatus;
assessing the accuracy of said personal identification characters by comparing signals derived from said key signal and said particular recording medium signal with signals derived from said personal identification characters; and
causing said locked content to be accessible when said assessment determines that said personal identification characters correspond to a particular recording medium signal and key signal.

In a subsidiary aspect in accordance with the invention's second broad independent aspect, the method further comprises the step of locking a display on a view which displays a message indicating said content is locked in response to an attempt to view locked content prior to entering said signal representative of said personal identification characters.

In a third broad independent aspect, the invention provides a communication apparatus located remotely from an individual entering into communication with said apparatus, comprising a module for:
receiving a key signal uniquely representative of an individual at a remote communication apparatus;
further receiving a signal representative of a specific recording medium;
determining a signal representative of one or more personal identification characters based on said key signal and said recording medium signal; and
transmitting said signal representative of said personal identification characters.

In a fourth broad independent aspect, the invention provides a recording medium which when read launches interactive menus, said recording medium comprising locked content which is unlockable, and a module for:
generating a data field for entry of a key signal uniquely representative of an individual;
generating a further data field for entry of a signal representative of one or more personal identification characters derived remotely by the individual's interaction with the remote communication apparatus of the preceding aspect;
assessing the accuracy of said personal identification characters by comparing signals derived from said key signal and said particular recording medium signal with signals derived from said personal identification characters; and
causing said locked medium to be accessible when said assessment determines that said personal identification characters correspond to a particular recording medium signal and key signal.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 shows a flow diagram for an embodiment of the invention operating with “short message service” (SMS) messaging.

FIG. 2 shows a second embodiment of the invention operating with “interactive voice response” (IVR).

### DETAILED DESCRIPTION OF THE PREFERRED EMBODIMENTS

Before describing the system in overview, an example of two separate modules one on a database server and the other on a DVD held by an individual is presented.

The Code

### Server

For the purposes of an example it is assumed that the telephone number used in order to obtain a PIN was 07790605582 and the product ID code is 59. The actual algorithm is a stored procedure on the database server, basically tSQL code (native to Microsoft SQL server) which runs on request.

Remove the last six digits of the phone number.

605582

Add the digits together for the sum

6+0+5+5+8+2=26

26 is referred to as the magic number
Square and store the above result 26*26=676
Convert the result to a four digit zero padded string 676 becomes 0676
This is the mSQUARE
Convert the product code into a four digit zero padded string based upon the square so 59 becomes 59*59=3481.
This is the pCODE
Convert the magic number to a two digit zero padded string 31 becomes 31 (only number below 10 will be adjusted)
The pre Pin becomes the magic number, msquare and pcode arranged as one string, hence.
   2606763481
In order to obtain the PIN extract digits in a set order to produce a five digit PIN. 2606763481
   ̂ - - - Digit 8=4
   ̂ - - - Digit 4=6
   ̂ - - - Digit 10=1
   ̂ - - - Digit 6=6
   ̂ - - - Digit 2=6
Therefore the returned PIN for telephone number 07790605582 and product ID 59 will be 46166

DVD
Upon entering a phone number the last six digits are stored in general purpose registers within the DVD player so that they can be used to confirm the PIN number

### EXAMPLE

07790605582
GPRM1 - - - ̂ GPRM1 set to 6
GPRM2 - - - ̂ GPRM2 set to 0
GPRM3 - - - ̂ GPRM3 set to 5
GPRM4 - - - ̂ GPRM4 set to 5
GPRM5 - - - ̂ GPRM5 set to 8
GPRM6 - - - ̂ GPRM6 set to 2
These numbers are then added together to produce the magic number, the result being stored in general purpose register zero (gprm0) and the square stored in general purpose register 1 (gprm(1)).
Set gprm(0)=(mov) 0
Set gprm(0)+=(add) gprm(1) Adds 6 to 0
Set gprm(0)+=(add) gprm(2) adds 0 to 6
Set gprm(0)+=(add) gprm(3) adds 5 to 6
Set gprm(0)+=(add) gprm(4) adds 5 to 11
Set gprm(0)+=(add) gprm(5) adds 8 to 16
Set gprm(1)+=(add) gprm(6) adds 2 to 24
Set gprm(1)=(mov) gprm(0) move 26 into gprm1 (magic number)
Set gprm(1)*=(mul) gprm(1) 26*26=676
The system then offers the PIN entry menu and stores the key presses into general purpose registers for verification.
46166
GPRM1 - - - ̂ GPRM2 set to 4
GPRM2 - - - ̂ GPRM3 set to 6
GPRM3 - - - ̂ GPRM4 set to 1
GPRM4 - - - ̂ GPRM5 set to 6
GPRM5 - - - ̂ GPRM6 set to 6
Once the pin has been entered control is transferred to the following code which verifies the PIN against the telephone number and partial product ID.
   1 Set gprm(7)=(mov) gprm(0)
   2 Set gprm(7)%=(mod) 10
   3 if (gprm(7)!=gprm(6)) then {LinkPGCN PGC 19}
   4 Set gprm(7)=(mov) gprm(1)
   5 Set gprm(7)%=(mod) 10
   6 if (gprm(7)!=gprm(5)) then {LinkPGCN PGC 19}
   7 Set gprm(12)=(mov) 1
   8 if (gprm(4)!=gprm(12)) then {LinkPGCN PGC 19}
   9 Set gprm(7)=(mov) gprm(1)
   10 Set gprm(8)=(mov) gprm(1)
   11 Set gprm(8)%=(mod) 100
   12 Set gprm(7)%=(mod) 1000
   13 Set gprm(7)−=(sub) gprm(8)
   14 Set gprm(7)/=(div) 100
   15 if (gprm(7)!=gprm(3)) then {LinkPGCN PGC 19}
   16 Set gprm(12)=(mov) 4
   17 if (gprm(2)!=gprm(12)) then {LinkPGCN PGC 19}
   18 Set gprm(0)=(mov) 999
   19 (JumpVTS_TT) Jump to TTN 1 in this VTS
   20 Set gprm(11)=(mov) 39
   21 LinkPGCN PGC 18
Line 1 gprm(0) already has the magic number stored in it (26) and this is now placed into gprm(7)
Line 2 divide gprm(7) by 10 and leave the remainder (26 mod 10=6) in gprm(7)
Line 3 Compares GPRM7 to GPRM6 (PIN digit 5(No. 6) to see if they are not equal, if this is the case it will jump to the wrong PIN page.
Line 4 Sets GPRM7 as GPRM1 (E.g. sets it to 676)
Line 5 GPRM7 takes the remainder (Modulo) after division by 10 The remainder is 6
Line6 Compares GPRM7 to GPRM5(PIN digit 4(No. 6) to see if they are not equal, if this is the case it will jump to the wrong PIN page.
Line 7 Sets GPRM12 as 1 (This is predetermined during DVD creation from the product ID and is a constant through the whole run of DVDS)
Line 8 Compares GPRM4(PIN digit 4(No. 1) to GPRM12 to see if they are not equal, if this is the case it will jump to the wrong PIN page.
Line 9 Sets GPRM7 to GPRM1 (Sets it to 676)
Line 10 Sets GPRM8 to GPRM1 (Sets it to 676)
Line 11 GPRM8 takes the remainder (Modulo) after division by 100 The remainder is 76
Line 12 GPRM7 takes the remainder (Modulo) after division by 1000. The remainder is 676
Line 13 GPRM7 is subtracted from GPRM8 (676−76=600)
Line 14 GPRM7 is divided by 100 (600/100=6)
Line 15 Compares to GPRM7 to GPRM3(PIN digit 2(No. 6) to see if they are not equal, if this is the case it will jump to the wrong PIN page
Line 16 Sets GPRM12 as 4 (This is predetermined during DVD creation from the product ID and is a constant through the whole run of DVDS)
Line 17 Compares to GPRM2(PIN digit 2(No. 4) to GPRM12(PIN digit 2(No. 6) to see if they are not equal, if this is the case it will jump to the wrong PIN page.
Line 18 Sets GPRM0 to 999 (This is only done if all the phone and pin information is correct—it allows access to the locked video)
Line 19 Jumps to the Locked Video

The system employs a common key which in this embodiment is a telephone number, the first module generates a PIN based around the unique key and a product ID code whilst the second module (operating from the DVD) uses the key and a partial product code to confirm a PIN for comparison.

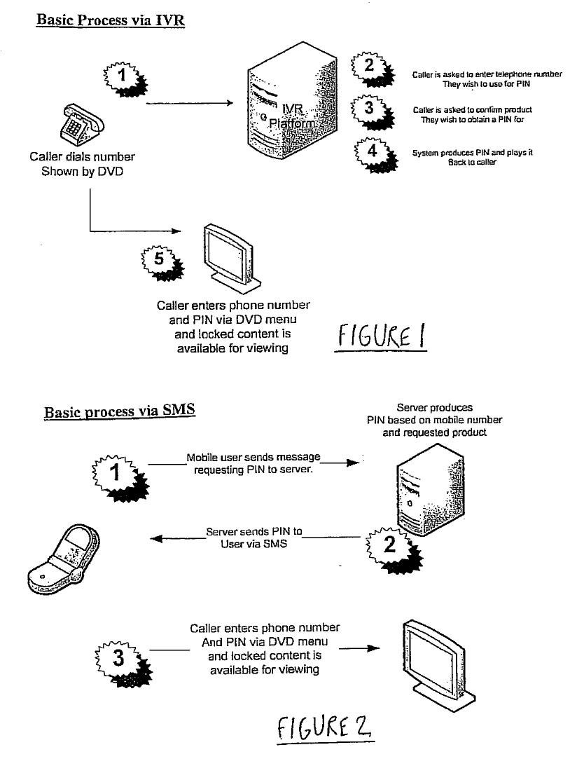

FIG. 1 shows the process, which would be followed when the invention employs SMS messaging. Upon playing the DVD or other recording medium, the individual would be prompted by a display on a display unit to send a key word to a given mobile sort code. A relay is provided to relay the message to a platform which by using the short code/key word combination can identify the product for which the individual wishes to purchase the PIN. When an SMS is sent a mobile network forwards the individual's mobile number to the SMS platform as required in order to facilitate the sending back of a reply. This telephone number is employed by the first module operating from the interactive voice response (IVR) platform, which employs the telephone number to derive the PIN. Alternatively, the caller is asked to enter the telephone number they wish to use for the derivation of the PIN. This key signal is uniquely representative of an individual and will be received by a receiver on the IVR platform.

The IVR platform sends an enquiry through its transmitter to a caller asking to confirm the product for which they wish to obtain a PIN. The caller sends a signal representative of a specific recording medium. This signal may for example be in numeric or an alphanumeric string of characters. Alternatively, the signal may be a digital signal containing an image representative of a particular product. Once the receiver receives both the key signal and the signal representative of specific recording medium, a generator derives the PIN, which is forwarded to a user dependant upon the completion of acceptable terms of purchase. Once the caller receives the PIN, he/she enters the phone number and PIN via a series of data fields, which are produced by a second module operating from the recording medium. A comparator or other means for assessing assesses the accuracy of the personal identification characters or PIN in order to allow locked content to be available for viewing. The system may be configured so that when a PIN has been generated the SMS system will return one or more messages to the individual's handset in order to generate the required revenue for the product. The system may be configured so that mobile short codes are chargeable at different rates. This system may also be configured to dispatch multiple messages in order to accumulate the required payment. The system may also be configured so that messages returned to individuals can be sent in real time or scheduled for later delivery.

FIG. 2 shows a system for controlling the access to locked content contained in a recording medium where the individual upon viewing a DVD is prompted to call a telephone number which may be a premium line. The receiver of the system answers the call and automatically identifies the number dialed and which product set is being referenced. The caller number is presented to the IVR platform. Then, the system asks the caller if he/she wants to use the number for his/her registration. This allows the caller to have the option to change the number or if no number was seen to enter one. The duration of the call and the tariff of the number determine the revenue returned per call. Once the receiver of the system receives a key signal uniquely representative of the caller which has his/her telephone number and the receiver receives a signal representative of a specific recording medium such as a product code, the system's generator determines a signal representative of one or more personal identification characters based on said key signal and said recording medium signal which is then sent from the server to a caller once the required revenue has been obtained. The caller may then make a note of the personal identification characters such as a PIN number and once it is entered, by employing the second module operating from the recording medium, the content may be unlocked.

As a further embodiment the communication between an individual and the system may be carried out through the Internet. In this embodiment, the individual is shown a website address and a product code/description. On visiting the site, the individual is required to enter the product code and a telephone number. The first module of the system will then operate to cause a generator to determine a signal representative of one or more personal identification characters based on the telephone number and the product code. Once the personal details of an individual are entered and the online payment is completed, the transmitter of the first module sends the personal identification characters or character, which may often be a simple PIN number to the individual for display through his/her web browser.

The system ensures the creation of a unique and random PIN number for both a particular DVD and a product set.

Whilst the preceding description has mentioned that the individual identification character or characters may be a telephone number, other appropriate numbers may be selected such as a serial number, a date of birth or other numeric or alphanumeric combination/sequence. The detailed description has also emphasized the particularly advantageous application of the invention to DVDs, however the invention may apply to any appropriate medium and would for example include within its scope relatively new technologies (at the time of writing) such blue-ray and high definition (HD). Particular advantages are achieved when employing media, which relies on the computer programming languages of players. One of these languages is currently preferred in the embodiments of the invention, which is called “virtual machine instruction set” (VMIS). The algorithms placed on the DVDs in order to interact with an individual's input. This system also employs in at least one embodiment VMIS to lock one or more portions of content held on a DVD. The system may also be adapted or configured to run as java applet which can be placed onto or into distributed media on such platforms as blue-ray but not restricted to blue-ray.

The system may be compatible with DVD mastering so that an operator may place, via publicly available software tools, the locking system around supplied copyright material. The locking is achieved by creating a menu on the DVD, which prompts for the entry of a PIN and telephone number, a series of VMIS commands may be used to authenticate the PIN and if correct use a link command to transfer to the start of the locked content. If authentication fails then a linked command is issued to redirect the code to a menu which prompts for the required PIN and telephone number again.

As detailed above, this system may employ an SMS interface which requires an Internet connection to either a mobile network or an improved mobile network aggregator which is a third party with direct connections to mobile networks. This system may operate in this embodiment from a personal computer (PC) with a module for handling the receipt and dispatch of SMS messages.

As detailed above, the system may also incorporate an IVR system requiring a series of PCs connected to high volume phone circuits. An interface card may be provided within the PCs in order to enable connection to multiple communication circuits in order to handle a greater volume of calls which would arrive simultaneously.

As detailed above, the system may be implemented via the Internet by means of an Internet web server. In one potential embodiment, the system may be embodied by a Microsoft operating system and Microsoft IIS server. Such pages may be created using a mixture of HTML and ASP code.

As detailed above, the system may employ a database for storing data. The database may be a Microsoft SQL database which runs on a high specification PC. The web, IVR and SMS embodiments may be configured to connect to this kind of database via network links.

In order to improve the security of the system, several viewing angles for each portion of video are considered. In this configuration, a single video stream is placed onto a view, which displays a message indicating the content is locked. If an attempt is made to view the locked portion prior to the PIN authentication and the individual is locked into viewing the protection/copyright message. Once a valid PIN is authenticated a VMIS command is issued which flips the view to show the unlocked video since this command can only be issued via the DVD, it becomes much more difficult for individuals to bypass the PIN protection.

Each recording medium such as a DVD may be issued with a product ID issued by the operator and a part, which is encoded onto the DVD via the VMIS. In the event that a third party attempts to use a PIN which was issued for a DVD with a different product code, the algorithm would fail to authenticate the PIN and the content would remain locked. If the third party would attempt to reverse engineer the algorithm, they will be missing the full product code, as it is not stored in its entirety on the DVD.

The system also envisages that the modules, which serve to derive the PIN sequences, may be varied in order to produce alternate PIN sequences. The invention also envisages changing the number of digits within a particular PIN. This would protect the system if the algorithm became public knowledge.

The system may also be adapted to collect and therefore receive more than a key signal uniquely representative of an individual and a signal representative a specific recording medium. For example, the system may formulate data requests such as age, postcode etc, which will allow the system to be used as a data-harvesting tool with or without payment for the final product.

The invention also envisages in an optional embodiment that multiple items of locked content are placed on a single recording medium each item with their own unique PIN. Items may be complete films, still images, chapters of a DVD or titles within a DVD.

The system is also language independent in order to operate for all DVD region codes.

Since the system is algorithm based it can be created using numerous development tools and run on most operating systems for which these development tools exist.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for controlling access to locked content contained in a recording medium, comprising:
a) a first module operating from a remote communication apparatus in conjunction with:
a receiver for receiving a key signal uniquely representative of an individual; and for further receiving a signal representative of a specific recording medium;
a generator for determining a signal representative of one or more personal identification characters based on said key signal and said recording medium signal; and
a transmitter for transmitting said signal representative of said personal identification characters to said individual;
b) a second module operating from said recording medium in conjunction with:
a generator for generating a data field for entry of said key signal; and for generating a further data field for entry of said signal representative of said personal identification characters; and
a comparator for assessing the accuracy of said personal identification characters which compares signals derived from said key signal and said particular recording medium signal with signals derived from said personal identification characters;
whereby when said comparator determines that said personal identification characters correspond to a particular recording medium signal and key signal, said second module causes said locked content to be accessible.

2. A system according to claim 1, wherein said specific recording medium signal incorporates a portion which is permanently stored on said recording medium which is common to a particular kind of recording medium and a portion which is specific to an individual recording medium.

3. A system according to claim 1, wherein said recording medium incorporates a plurality of viewing angles for a plurality of video portions; and wherein a single video stream is located onto one of said views which displays a message indicating said content is locked whilst said content is located on another view.

4. A system according to claim 3, further comprising means for locking a display on said view in response to an attempt to view locked content prior to entering said signal representative of said personal identification characters.

5. A system according to claim 1, wherein said key signal is a telephone number.

6. A method for controlling access to locked content contained in a recording medium, comprising the following steps:
receiving a key signal uniquely representative of an individual at a remote communication apparatus;
further receiving a signal representative of a specific recording medium;
determining a signal representative of one or more personal identification characters based on said key signal and said recording medium signal;
transmitting said signal representative of said personal identification characters;
generating a data field for entry of said key signal by reading said recording medium in a reading apparatus;
generating a further data field for entry of said signal representative of said personal identification characters by reading said recording medium in a reading apparatus;
assessing the accuracy of said personal identification characters by comparing signals derived from said key signal and said particular recording medium signal with signals derived from said personal identification characters; and
causing said locked content to be accessible when said assessment determines that said personal identification characters correspond to a particular recording medium signal and key signal.

7. A method according to claim 6, further comprising the step of locking a display on a view which displays a message indicating said content is locked in response to an attempt to view locked content prior to entering said signal representative of said personal identification characters.

8. A communication apparatus located remotely from an individual entering into communication with said apparatus, comprising a module for:
receiving a key signal uniquely representative of an individual at a remote communication apparatus;
further receiving a signal representative of a specific recording medium;
determining a signal representative of one or more personal identification characters based on said key signal and said recording medium signal; and
transmitting said signal representative of said personal identification characters.

9. A recording medium which when read launches interactive menus, said recording medium comprising locked content which is unlockable, and a module for:
generating a data field for entry of a key signal uniquely representative of an individual;
generating a further data field for entry of a signal representative of one or more personal identification characters derived remotely by the individual's interaction with the remote communication apparatus of claim 8;
assessing the accuracy of said personal identification characters by comparing signals derived from said key signal and said particular recording medium signal with signals derived from said personal identification characters; and
causing said locked medium to be accessible when said assessment determines that said personal identification characters correspond to a particular recording medium signal and key signal.
